(19) United States
(12) Patent Application Publication
(10) Pub. No.: US 2017/0292551 A1
(43) Pub. Date: Oct. 12, 2017

(54) JOINT DEVICE AND GUIDE ARRANGEMENT

(71) Applicant: Airbus Operations GmbH, Hamburg (DE)

(72) Inventors: Hermann Benthien, Hamburg (DE); Andreas Poppe, Hamburg (DE)

(21) Appl. No.: 15/473,342

(22) Filed: Mar. 29, 2017

(30) Foreign Application Priority Data
Apr. 8, 2016 (DE) 102016205934.3

(51) Int. Cl. F16B 9/00; B64C 1/06; B64D 11/02; F16B 21/08

(52) U.S. Cl. CPC F16B 9/00; F16B 21/08; B64C 1/061; B64D 11/02

(57) ABSTRACT

A joint device rotatably connecting a functional component to a fixing structure includes a bearing shell having a first guide body with a curved first guide face, and a second guide body with a second guide face. The bearing shell connects to either the functional component or the fixing structure. An inner body having a connection portion and a guide portion is arranged between the first and second guide faces. The connection portion connects to the other of the functional component or the fixing structure. The guide portion is movably guided on the first and second guide faces about a first rotational axis defined by the curved first guide face. The connection portion or the bearing shell connects to the fixing structure by a pin. A second rotational axis extending transversely to the first rotational axis is defined by a pin central axis and/or the first guide face curvature.

### CROSS-REFERENCES TO RELATED APPLICATIONS

This application claims the benefit of the German patent application No. 10 2016 205 934.3 filed on Apr. 8, 2016, the entire disclosures of which are incorporated herein by way of reference.

### FIELD OF THE INVENTION

The present invention relates to a joint device, in particular to a joint device for connecting a functional component and a fixing structure, in particular of an aircraft or spacecraft, and to a guide arrangement.

### BACKGROUND OF THE INVENTION

From the general prior art, joints for connecting a functional component and a fixing structure are known in which the joint comprises a first axis of rotation and a second axis of rotation which is oriented perpendicularly to the first axis of rotation. In aircraft, such joints are used, for example, in order to connect equipment components, such as a galley or toilet cubicles, which are arranged in the interior of the aircraft fuselage to the fuselage structure in an articulated manner via functional components, such as a rod or a strut. For this purpose, the fuselage structure comprises a corresponding fixing structure, to which the joint can be connected.

EP 2 125 508 B1 discloses a joint device comprising a first cylindrical nut, into which a rod is screwed, and a second cylindrical nut, in which the first cylindrical nut is guided about a first axis of rotation. An outer face of the second cylindrical nut is in turn guided on a fixing structure so as to be able to rotate about a second axis of rotation. For this purpose, the fixing structure comprises a thickening, in which a corresponding guide face is provided for the second cylindrical nut.

### SUMMARY OF THE INVENTION

One of the ideas of the present invention is to provide a joint device which has a compact construction and can be mounted in a simple manner on a fixing structure.

A further idea of the present invention is to provide a guide arrangement which has a compact construction and can be mounted in a simple manner.

According to a first aspect of the invention, a joint device is provided for rotatably connecting a functional component to a fixing structure, in particular a fixing structure of an aircraft or spacecraft. The joint device comprises a bearing shell having a first guide body which has a first guide face extending in a curved manner, and a second guide body which is arranged in a stationary manner with respect to the first guide body, which second guide body has a second guide face which faces the first guide face of the first guide body, wherein the bearing shell can be connected to one part from the group comprising the functional component and the fixing structure.

The joint device further comprises an inner body having a connection portion and a guide portion arranged between the first and the second guide face, wherein the connection portion can be connected to the other part from the group comprising the functional component and the fixing structure.

The guide portion of the inner body is guided in a movable manner on the first and the second guide face about a first axis of rotation which is defined by the curvature of the first guide face. Furthermore, the connection portion of the inner body or the bearing shell can be connected to the fixing structure by at least one pin, wherein a second axis of rotation extending transversely to the first axis of rotation is defined by a central axis of the pin and/or the curvature of the first bearing face.

The first guide face has a curvature in at least a first curvature direction having a constant first radius of curvature about a first center of curvature. The curvature of the first guide face thus defines the first axis of rotation of the joint device, which extends through the center of curvature of the curvature of the first guide face. In the case of a curvature in only the first curvature direction, a cylindrical curvature of the first guide face is defined.

In addition to the curvature in the first curvature direction, the first guide face can also be curved in a spherical curvature direction, which extends perpendicularly to the first curvature direction. The curvature in the spherical curvature direction has the same center of curvature, and the radius of curvature is equal to that of the curvature in the first curvature direction. Thus, a spherical curvature of the first guide face is defined.

The second guide face of the second guide body is provided to keep the inner body, in particular a guide portion of the inner body, in contact with the first guide face. For this purpose, the second guide face can advantageously also have a curvature. In some embodiments, the second guide face may also have a curvature in at least a first curvature direction having a constant second radius of curvature about a second center of curvature which is the same as the first center of curvature. However, it is also conceivable for the second guide face to have a planar design or to be designed with a smaller or greater radius of curvature.

For guiding on the first and the second guide face, the guide portion comprises, in particular, an outer surface, wherein a first bearing region of the outer surface facing the first guide face bears against the first guide face and is thereby guided thereon. A second bearing region, which has the opposite orientation to the first bearing region, bears against the second guide face of the bearing shell. In this way, the guide portion of the inner body is arranged between the first and the second guide body of the bearing shell. The guide portion of the inner body is consequently guided in a movable manner on the first and the second guide face about the first axis of rotation. As described above, the first axis of rotation is defined by the curvature of the first guide face. The first bearing region of the outer surface of the guide portion can be formed, in particular, so as to be complementary to the first guide face, so that the first bearing region bears against the face in a planar manner. However, it can also be provided that individual contact portions of the first bearing region bear against the first guide face only in places. For example, the first bearing region can comprise protruding ribs or studs which form the contact portions.

The at least one pin may, in some embodiments, define the second axis of rotation of the joint device, for example, in that the pin itself can be rotatably fixed to the fixing structure, or in that the bearing shell or the inner body can be rotatably mounted on the pin. However, it is also possible for the pin to fix the bearing shell or the inner body to the fixing structure in a stationary manner or for conjoint rotation, and for the second axis of rotation to be defined by the curvature of the first guide face.

The pin provides a simple connection of the joint device to the fixing structure. As a result of the fact that at least the first axis of rotation is defined by the curvature of the first guide face, the first axis of rotation can be located, for example, outside the guide portion of the inner body. This has the advantage, in particular, that the connection portion is designed to be independent of the first axis of rotation and, in particular, can be adapted to the installation space which is available for the joint device. In this way, a compact construction of the joint device can be achieved. By means of the combination of a pin which defines the second axis of rotation and a bearing shell having a first guide face which defines the first axis of rotation, the joint device can be produced with a cardan functionality in an extremely compact manner and with a small number of components.

According to a first embodiment of the joint device, it can be provided that the connection portion of the inner body can be connected to the fixing structure by means of the at least one pin in such a way that the pin defines the second axis of rotation, and the connection portion can be rotated about the second axis of rotation, or in such a way that the connection portion is arranged in a stationary manner with respect to the fixing structure, and the second axis of rotation is defined by the curvature of the first guide face, and the bearing shell can be connected to the functional component.

In the first embodiment of the joint device, in the case where the connection portion can be connected to the fixing structure by means of the pin so as to be able to rotate about the second axis of rotation, the connection portion can be formed by two tabs protruding from the guide portion of the inner body. The tabs each have a guide recess, through which the pin extends. This has the advantage that an advantageous adaptation to the fixing structure can take place through the tabs, for example by selecting the length of the tabs or the distance between the tabs. Alternatively to a pin which extends through the two recesses in the tabs, it is also possible to provide one pin per tab and associated recess.

In addition to the tabs, it can be provided, in particular, that the second guide body has a convex/concave design, wherein an end face which has the opposite orientation to the second guide face has a curvature which is the opposite of the curvature of the second guide face. This thus results in a shell-shaped design of the second guide body. This has the advantage that the second guide body can be produced with low material costs and thus has a low weight. Furthermore, the second guide body can receive components of the fixing structure in an open cavity resulting from the shell-shaped design without this impairing the movability of the bearing shell relative to the inner body. A very compact construction of the joint device is thus provided.

At a peripheral portion of the second guide body connecting the second guide face and the end face, an undercut recess can further be formed. The recess further increases the pivotability of the bearing shell about the first axis of rotation. This is advantageous, in particular, when the fixing structure has a rectangular cross section and protrudes into the open cavity in the second guide body resulting from the shell-shaped design.

In the first embodiment of the joint device, in the case where the connection portion can be connected by means of the pin to the fixing structure so as to be able to rotate about the second axis of rotation, the first guide body has an end face which has the opposite orientation to the first guide face for fixing to a first region of a mounting surface of the functional component, and the second guide body can have a second end face which has the opposite orientation to the second guide face for fixing to a second region of the mounting surface of the functional component. This construction makes it possible to integrate the bearing shell into an interior of the functional component, for example when the component is in the form of a hollow part, such as a pipe or a conduit.

In the case of the aforementioned design of the joint device comprising opposed end faces formed on the guide bodies, it can be provided, in particular, that the first and the second guide face each have a concave curvature having the same center of curvature. Alternatively to this, it can be provided that the first and the second guide face respectively have opposite curvatures to one another, having the same center of curvature. For example, the first guide face can be curved concavely, and the second guide face can be curved convexly. In both cases, an outer surface of the guide portion of the inner body which has bearing regions that are curved in a complementary manner to the guide faces bears against the guide faces.

Generally, in the case of the joint device according to the first embodiment, it can be provided that the first guide face is curved in a cylindrical or spherical manner, as has already been described at the outset. A cylindrical curvature has the advantage of being simple to produce. In this way, undesirable rotation of the bearing shell relative to the inner body about an axis of rotation extending transversely to the first and the second axis of rotation also prevents the first guide face and the bearing region formed on the guide portion of the inner body from forming an interlocking fit with respect to the axis of rotation. By contrast, by means of a spherical curvature, the degrees of freedom of the joint device are increased, by means of which, for example, a moment rotating about the axis of rotation is transmitted to the bearing shell.

In the case of the joint device according to the first embodiment, it can further be provided that, in the case where the connection portion can be connected to the fixing structure in such a way that the connection portion is arranged in a stationary manner with respect to the fixing structure, the first guide face defines the second axis of rotation in that the face is spherically curved in a convex or concave manner, In this case, it can be provided, in particular, that the second guide face has an opposite curvature to the first guide face, and an outer surface of the guide portion of the inner body which has bearing portions that are curved in a complementary manner to the guide faces bears against the guide faces. This has the advantage that the second guide body can be formed, for example, in one piece with a fixing shaft, which can have, in particular, a thread. Thus, the second guide body and the fixing shaft form a fixing screw which comprises a screw head in the form of the second guide body. The joint device can thus be mounted in a very simple manner.

Generally, in the case of the joint device according to the first embodiment, it can additionally be provided that the first guide body is formed or arranged on an end portion of the functional component. In this case, the end portion comprises the first guide face. Advantageously, the first guide body can be formed in one piece with the end portion of the functional component. However, it is also conceivable for the first guide body to be connected to the end portion by means of a fixing device such as a threaded rod, a pin or the like. The first guide body can also be adhered or welded to the end portion. For example, the first guide body can be connected to the end portion of the functional component by means of a fixing shaft, on which the second guide body is formed or arranged or can be arranged.

Generally, in the case of the joint device according to the first embodiment, it can be provided that the second guide body can be arranged in a stationary manner with respect to the first guide body by means of a fixing shaft, the fixing shaft being connected to the first and the second guide body. This has the advantage that the bearing shell per se is constructed in a sturdy and compact manner.

A stationary arrangement of the second guide body with respect to the first guide body by means of the fixing shaft can be achieved, in particular, in that the fixing shaft is formed in one piece with the first guide body and the second guide body. A construction of this type of the bearing shell can be produced particularly advantageously, for example in a 3D-printing process. By forming the fixing shaft, the first guide body and the second guide body in one piece, the bearing shell is formed in one piece. This means that no assembly steps are required for assembling the bearing shell, as a result of which the joint device as a whole is easy to assemble.

It can also be provided that the fixing shaft is formed in one piece with the first guide body and protrudes from the first guide face, and the second guide body has a recess in which the fixing shaft is received with an interlocking and/or force fit. Thus, the second guide body can advantageously be pushed or screwed onto the first guide body.

According to another alternative, it can be provided that the fixing shaft is formed in one piece with the second guide body and protrudes from the second guide face, and the first guide body has a recess in which the fixing shaft is received with an interlocking and/or force fit. In this case as well, the second guide body can advantageously be pushed or screwed onto the first guide body.

According to a second embodiment of the joint device, it is provided that the bearing shell can be connected to the fixing structure by means of the at least one pin in such a way that the pin defines the second axis of rotation, and the bearing shell can be rotated about the second axis of rotation, or that the bearing shell can be connected to the fixing structure by means of the at least one pin in such a way that the bearing shell is arranged in a stationary manner with respect to the fixing structure, and the connection portion of the inner body can be connected to the functional component.

In the second embodiment of the joint device, it can be provided that the first guide body comprises an end face which has the opposite orientation to the first guide face for bearing against a first portion of the fixing structure, and the second guide body comprises an end face which has the opposite orientation to the second guide face for bearing against a second portion of the fixing structure, and the connection portion of the inner body is designed for connection to the functional component. The first and the second portion of the fixing structure can be, for example, inner faces of a U-shaped beam.

By means of the design of the guide body with end faces which are positioned opposite the guide faces, which are designed to bear against the fixing structure, the bearing shell and thus the joint device can be assembled on the fixing structure in a particularly compact manner.

The guide body can be, in particular, in the form of two separate components. This has the advantage that the distance between the bearing shells can be adapted to the fixing structure. A stationary arrangement of the guide bodies relative to one another can also be achieved by the guide bodies bearing against the fixing structure, without an additional component being required for this purpose.

The first and the second guide body can also be connected by a web, which is formed, in particular, in one piece with the first and the second guide body or can be respectively fixed thereto. Through the web, any expanding forces which may occur as a result of a tensile force acting along the longitudinal axis of the functional component, which expanding forces act as a result of the curvature of the guide faces, are not transmitted, or are only transmitted to a limited extent, to the fixing structure.

In the second embodiment of the joint device, when the guide body is designed with end faces which are positioned opposite the guide faces, which are designed to bear against the fixing structure, it can further be provided that the pin extends through openings formed respectively in the first and the second guide body and the guide portion of the inner body. Alternatively to this, it can be provided that in each case, a pin engages from the end face of the respective guide body into the opening of the respective guide body.

In the second embodiment of the joint device, when the guide body is designed with end faces which are positioned opposite the guide faces, which are designed to bear against the fixing structure, it can be provided that the connection portion of the inner body is in the form of a fixing recess extending transversely to the first axis of rotation, in particular as a through-hole, an end portion of the functional component being able to fixed in the fixing recess. The end portion of the functional component can preferably be able to be screwed into the fixing recess. However, it can also be provided that the end portion is adhered in the fixing recess or engages therein. The functional component can thus be connected to the connection portion of the inner body in a simple manner Since the connection portion is formed inside the guide portion, the inner body of the joint device has a very compact construction.

In addition to the fixing recess, it is provided that a wall of the first guide body and a wall of the second guide body form an introduction opening in the bearing shell, through which the end portion of the functional component can be guided, in particular, can be introduced into the fixing recess in the inner body. In addition to this, it can advantageously be provided that the wall of the first guide body and the wall of the second guide body form a functional opening in the bearing shell which is positioned opposite the introduction opening. This has the advantage that cable or actuating elements, such as cable pulls, fluid lines, electric cables or the like, extending inside the functional component can be guided through the bearing shell.

In the second embodiment of the joint device, as an alternative to the first and the second guide body having end faces for bearing against the fixing structure, it can be provided that only the first guide body has an end face which has the opposite orientation to the first guide face for bearing against a first portion of the fixing structure. In this case, it is provided, in particular, that the pin is formed in one piece with the second guide body and protrudes from the second guide face thereof. In this case, the second guide body is arranged in a stationary manner with respect to the first guide body in that the pin extends through openings formed in the first guide body and the guide portion of the inner body and can be fixed to the fixing structure. This design of the bearing shell has the advantage that the first guide body can be assembled on a fixing structure having practically any desired design.

In the second embodiment of the joint device, it can generally be provided that, in the case where the bearing shell can be connected to the fixing structure by means of the at least one pin in such a way that the pin defines the second axis of rotation and the bearing shell can be rotated about the second axis of rotation, the first guide face is curved in a spherical or cylindrical manner. In the case where the connection portion is arranged in a stationary manner with respect to the fixing structure, the first guide face is curved in a spherical manner and defines the second axis of rotation.

According to a further aspect of the invention, a guide arrangement is provided. The arrangement comprises a functional component, a fixing structure and a joint device according to any of the above-described embodiments. The fixing structure is formed by a U-shaped profile which comprises two lateral struts which are opposite one another and a transverse strut which extends transversely thereto and connects the struts. The lateral struts of the fixing structure each comprise a recess in which the pin of the joint device is mounted.

The fixing structure can be formed, for example, by a frame of a fuselage of an aircraft or can be fixed to a fuselage structure of a fuselage of an aircraft.

In the case of the guide arrangement, it can be provided, in particular, that the lateral struts have elevations and depressions alternately on the end portion thereof, a portion of the functional component being able to be received in one of the depressions during the movement of the component about the first axis of rotation. In this way, the movement space which is available to the functional component during the movement thereof about the first axis of rotation can advantageously be enlarged. The depressions in the lateral struts would also lead to a saving in terms of material and thus weight.

With respect to a plurality of structural components which are formed “in one piece,” “as one piece” or “integrally,” this is generally understood to mean that the components are produced as a material unit and, in particular, do not have any contact points or faces at which the components are connected by a connecting element.

With respect to directional information and axes, in particular directional information and axes which relate to physical structures, an extension of an axis, a direction or a structure “along” another axis, direction or structure is understood to mean that these, in particular, the tangents which are produced at a respective point on the structures, each extend at an angle of less than or equal to 45 degrees, preferably of less than or equal to 30 degrees, and, in particular, preferably extend in parallel with one another.

With respect to directional information and axes, in particular, directional information and axes which relate to physical structures, an extension of an axis, a direction or a structure “transversely to” another axis, direction or structure is understood to mean that these, in particular, the tangents which are produced at a respective point on the structures, each extend at an angle of greater than or equal to 45 degrees, preferably of greater than or equal to 60 degrees, and, in particular, preferably extend perpendicularly to one another.

### BRIEF DESCRIPTION OF THE DRAWINGS

In the following, the invention will be described in greater detail with reference to the figures of the drawings, in which:

FIG. 1 is a plan view along a first axis of rotation of a joint device according to one embodiment of the present invention, wherein the joint device is shown assembled on a functional component, and an inner body of the joint device can be connected to a fixing structure;

FIG. 2 is a plan view of the joint device according to one variant of the embodiment shown in FIG. 1;

FIG. 3 is a plan view of the joint device according to another variant of the embodiment shown in FIG. 1;

FIG. 4 is a side view along a second axis of rotation of the joint device shown in FIG. 1;

FIG. 5 is a plan view along the first axis of rotation of the joint device shown in FIG. 3 in a state in which the device is additionally shown assembled on a fixing structure;

FIG. 6 is a plan view in a viewing direction which is transverse to the first and the second axis of rotation of the joint device of one embodiment of the inner body of the joint device according to an embodiment of the present invention;

FIG. 7 is a plan view in a viewing direction which is transverse to the first and the second axis of rotation of the joint device of another embodiment of the inner body of the joint device according to an embodiment of the present invention;

FIG. 8 is a plan view of the joint device according to one variant of the embodiment shown in FIG. 3 having an alternative inner body;

FIG. 9 is a plan view along the first axis of rotation of one variant of the joint device shown in FIG. 8 in a state in which the device is additionally shown assembled on a fixing structure;

FIG. 10 is a side view along the second axis of rotation of the joint device shown in FIG. 8 in a state in which the device is additionally shown assembled on a fixing structure;

FIG. 11 is a plan view along the first axis of rotation of a joint device according to another embodiment of the present invention, wherein the joint device is shown assembled on a functional component and a fixing structure, and the bearing shell of the joint device can be connected to a fixing structure;

FIG. 12A is a sectional view of the joint device shown in FIG. 11 which results from a section along the line A-A drawn in FIG. 11;

FIG. 12B is a sectional view of one variant of the joint device shown in FIG. 11 which results from a section along the line A-A drawn in FIG. 11;

FIG. 13 is a plan view along the first axis of rotation of one variant of the embodiment of the joint device shown in FIG. 11;

FIG. 14 is a plan view along the first axis of rotation of a joint device according to another embodiment of the present invention, wherein the joint device is shown assembled on a functional component and a fixing structure, and the inner body of the joint device can be connected to a fixing structure;

FIG. 15 is a plan view along the first axis of rotation of one variant of the embodiment of the joint device shown in FIG. 14;

FIG. 16 is a plan view along the first axis of rotation of another variant of the embodiment of the joint device shown in FIG. 11;

FIG. 17 is a plan view along the first axis of rotation of a joint device according to another embodiment of the present invention, wherein the joint device is shown assembled on a functional component and a fixing structure, and the bearing shell of the joint device can be connected to a fixing structure;

FIG. 18 shows the joint device shown in FIG. 17, comprising a functional component shown in a sectional view, which component is in the form of a hollow part;

FIG. 19 shows the joint device shown in FIG. 17, wherein one variant of the connection between the pin of the joint device and the fixing structure and the bearing shell of the joint device, which is shown in FIG. 17, is shown schematically;

FIG. 20 is a plan view along the first axis of rotation of a joint device according to another embodiment of the present invention, wherein the joint device is shown assembled on a functional component and a fixing structure, and the inner body of the joint device can be connected to a fixing structure;

FIG. 21 is a sectional view of the functional component shown in FIG. 20 which results from a section along the line B-B drawn in FIG. 20;

FIG. 22 is a plan view of the joint device according to one variant of the embodiment shown in FIG. 20;

FIG. 23 is a plan view of the joint device according to another variant of the embodiment shown in FIG. 20;

FIG. 24 is a side view of a guide arrangement according to one embodiment of the present invention comprising a joint device in a viewing direction along the second axis of rotation of the joint device; and

FIG. 25 is a sectional view of the guide arrangement shown in FIG. 24 which results from a section along the line C-C drawn in FIG. 24.

### DETAILED DESCRIPTION OF THE PREFERRED EMBODIMENTS

In the drawings, the same reference numerals denote like or functionally like components, unless stated otherwise.

According to the present invention, a joint device 1 for rotatably connecting a functional component 2 to a fixing structure 3 and a guide arrangement 100 is provided.

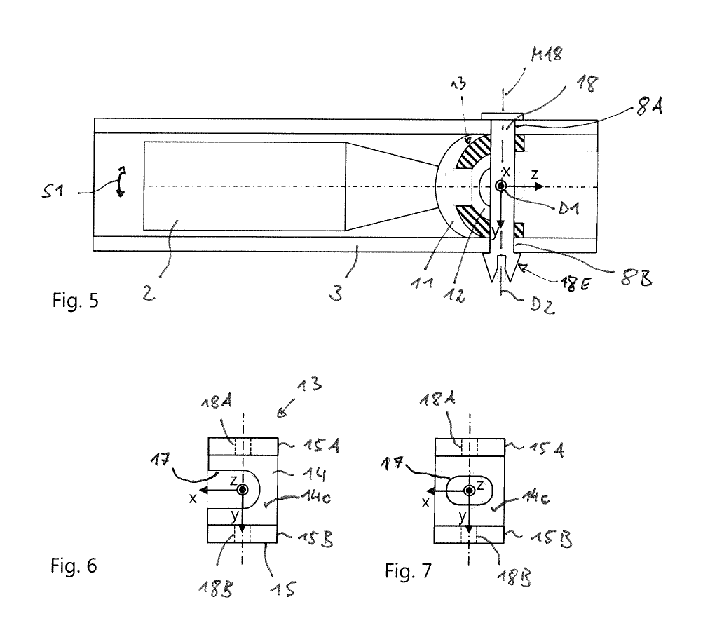

The fixing structure 3 can be, in particular, a fixing structure provided on an aircraft or spacecraft. For example, the fixing structure 3 can be formed by a frame of a fuselage (not shown). The fixing structure 3 can have, in particular, a U-shaped cross-sectional profile, as is shown by way of example, in particular, in FIGS. 5, 12A, 12B and 25. However, the fixing structure 3 can also have an I-shaped or T-shaped cross-sectional profile or a similar cross-sectional profile. FIGS. 9 and 10, and FIGS. 14 to 16 show, by way of example, fixing structures 3 having I-shaped cross-sectional profiles.

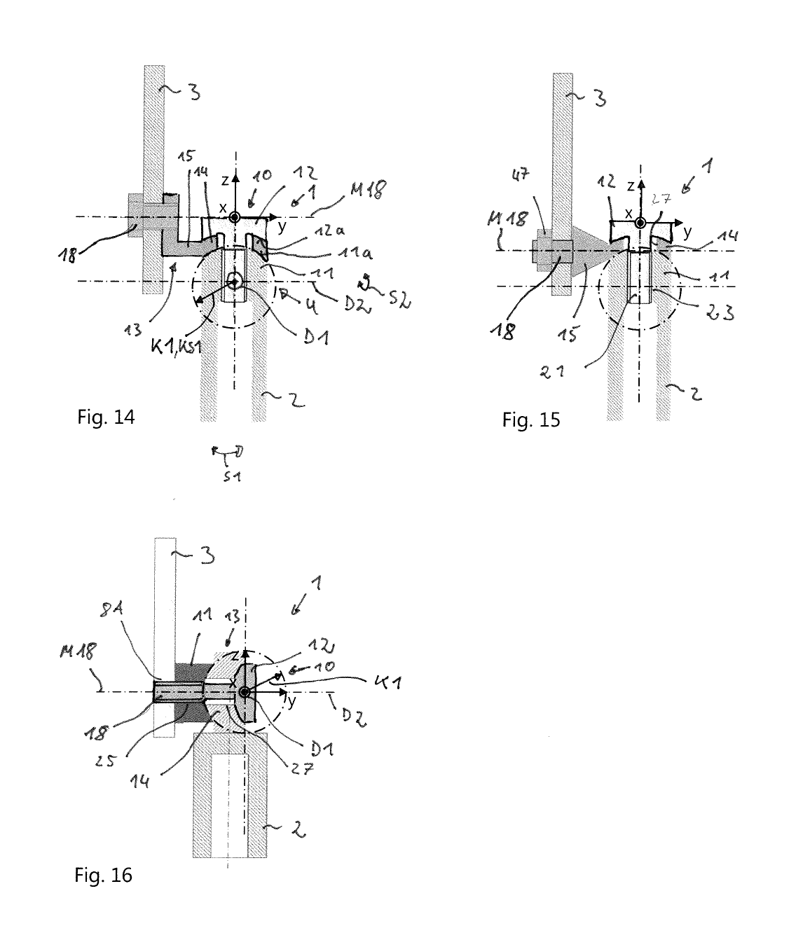

The functional components 2 can generally be in the form of a connecting rod, a first end portion 4 of which can be connected to the joint device 1, and an assembly portion (not shown) of which, which is positioned opposite the first end portion 4, can be connected to a component, e.g. to a structure such as a toilet cubicle which is arranged in the interior of an aircraft, or to another joint device. The functional component 2 can also be, for example, in the form of a damper element which has an adjustable length. Furthermore, it can be provided that the functional component 2 is shown as a hollow part, as is shown by way of example in FIGS. 14 to 16 and 18. The functional component 2 can generally have a tubular or polygonal cross-sectional shape.

The joint device 1 generally comprises a bearing shell 10 having a first guide body 11 and a second guide body 12. The first guide body 11 comprises a first guide face 11a extending in a curved manner. The second guide body 12 is arranged in a stationary manner with respect to the first guide body 11 and comprises a second guide face 12a facing the first guide face 11a of the first guide body 11.

The first guide face 11a of the first guide body 11 guides a movement of an inner body 13 of the joint device 1 which is described in greater detail in the following. The first guide face 11a has a curvature in at least a first curvature direction having a constant first radius of curvature K1 about a first center of curvature. The curvature of the first guide face 11a thus defines a first axis of rotation D1 of the joint device 1, which extends through the center of curvature of the curvature of the first guide face 11a.

The second guide face 12a of the second guide body 12 is provided to keep the inner body 13, in particular, a guide portion 14 of the inner body 13, in contact with the first guide face 11a. For this purpose, the second guide face 12a can advantageously also have a curvature. Preferably, the second guide face 12a also has a curvature in at least a first curvature direction having a constant second radius of curvature K2 about a second center of curvature which is the same as the first center of curvature. However, it is also conceivable for the second guide face 12a to have a planar design.

As already described, the joint device 1 further comprises an inner body 13 having a connection portion 15 and a guide portion 14 which is arranged between the first and the second guide face 11a, 12a.

The connection portion 15 is provided for connection to the functional component 2 or the fixing structure 3.

The guide portion 14 comprises an outer surface 14a, wherein a first bearing region 14b of the outer surface 14a facing the first guide face 11a bears against the first guide face 11a and is guided on the face as a result. A second bearing region 14c which has the opposite orientation to the first bearing region 14b bears against the second guide face 12a of the bearing shell 10. In this way, the guide portion 14 of the inner body 13 is arranged between the first and the guide body 11, 12 of the bearing shell. The guide portion 14 of the inner body 13 is consequently guided in a movable manner on the first and the second guide face 11a; 12a about the first axis of rotation D1. As described above, the first axis of rotation D1 is defined by the curvature of the first guide face 11a.

According to the present invention, the bearing shell 10 can be connected to one part from the group comprising the functional component 2 and the fixing structure 3. The connection portion 15 of the inner body 13 can be connected to the other part from the group comprising the functional component 2 and the fixing structure 3.

Due to the above-described construction of the joint device 1, firstly a pivotability of the bearing shell 10 and of the inner body 13 relative to one another about the first axis of rotation D1 in a first pivoting direction S1 is facilitated. Furthermore, a pivotability of the bearing shell 10 and of the inner body 13 relative to one another about the second axis of rotation D2 in a second pivoting direction S2 is facilitated. The functional component 2 can thus be moved or pivoted relative to the fixing structure 3 both in the first and in the second pivoting direction S1, S2.

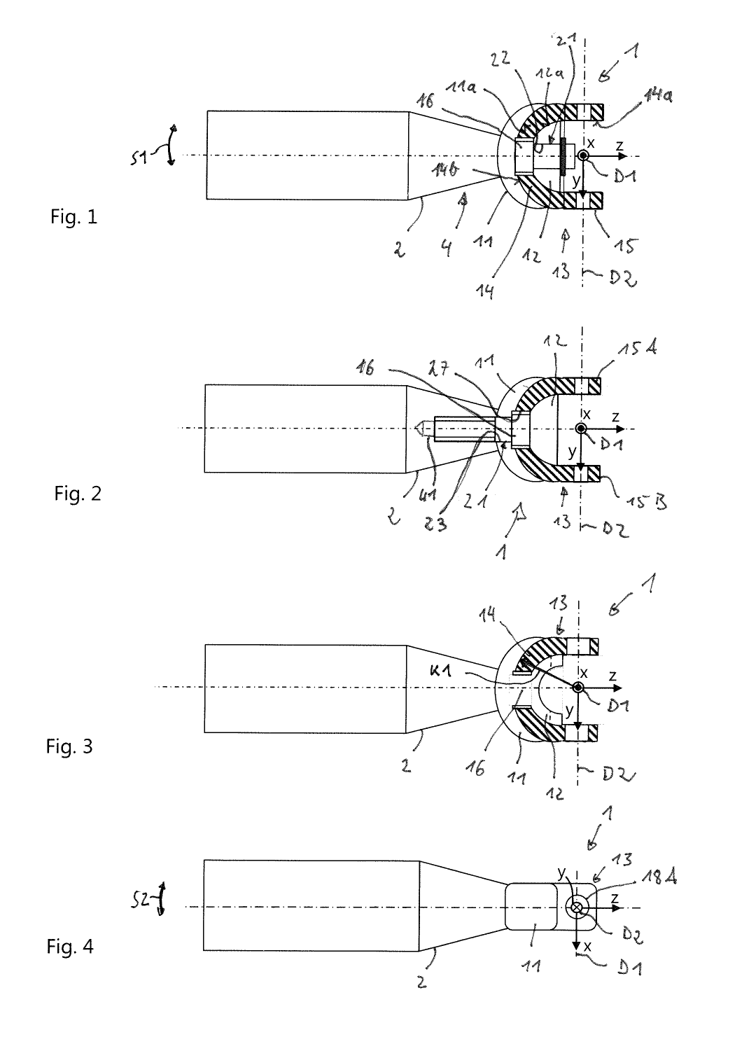

FIGS. 1 to 5, 8 to 10, 14, 15, 20, 22 and 23 each show embodiments of the joint device 1 in which the connection portion 15 of the inner body 13 can be connected to the fixing structure 3, and the bearing shell 10 can be connected to the functional component 2.

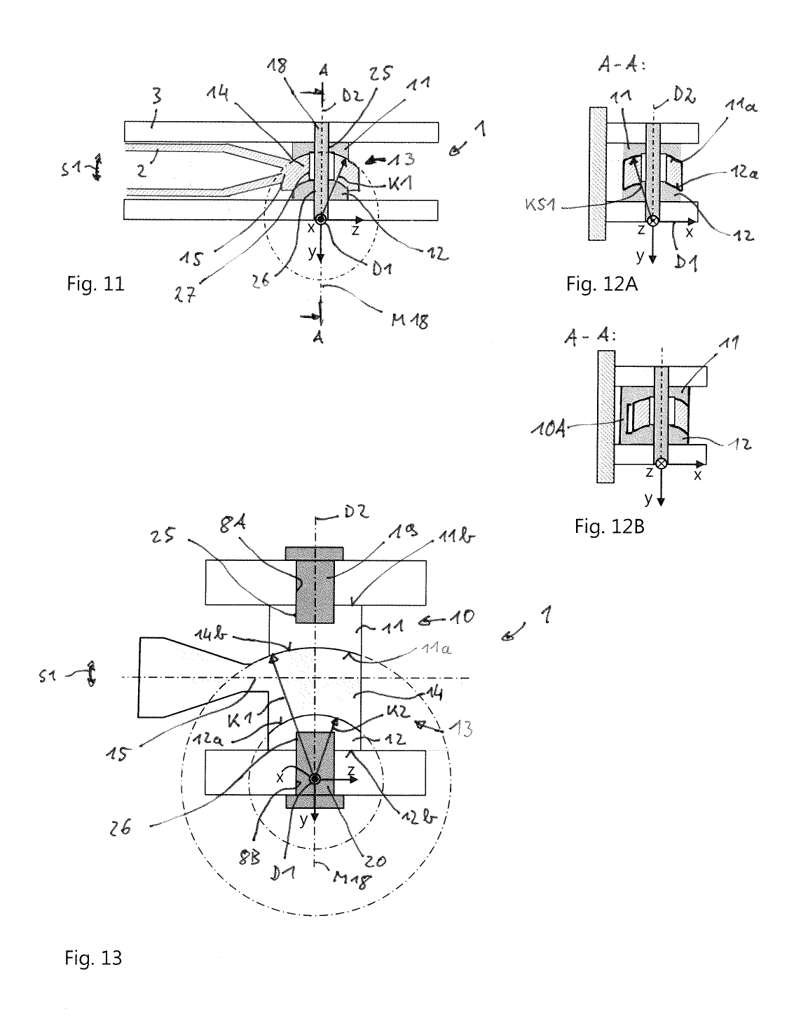

FIGS. 11 to 13, 16 to 19 and 25 each show embodiments of the joint device 1 in which the bearing shell 10 can be connected to the fixing structure 3, and the connection portion 15 of the inner body 13 can be connected to the functional component 2.

In order to connect the connection portion 15 of the inner body 13 or the bearing shell 10 to the fixing structure 3, the joint device 1 comprises at least one pin 18, 19, 20.

A second axis of rotation D2 extending transversely to the first axis of rotation D1 can be defined by a central axis M18 of the pin 18, 19, 20. In this case, the part of the joint device 1 from the group comprising the bearing shell 10 and the connection portion 15 of the inner body 13, which is provided for connection to the fixing structure 3, is rotatably mounted by the pin 18, 19, 20.

Alternatively or in addition to this rotatable mounting, the second axis of rotation D2 can also be defined by the curvature of the first guide face 11a. In this case, the first guide face 11a has, in addition to the curvature in the first curvature direction, a curvature in a curvature direction extending perpendicularly to the first curvature direction which has a spherical radius of curvature KS1 which is equal to the first radius of curvature K1 and has the same center of curvature. This thus results in a spherical curvature of the first guide face 11a. The curvature of the guide face 11a in the second curvature direction thus defines in this case the second axis of rotation D2 of the joint device 1, which extends through the center of curvature of the curvature of the first guide face 11a.

Preferably, the central axis M18 of the at least one pin 18, 19, 20 likewise extends through the center of curvature of the first guide face 11a, as is shown, for example, in FIG. 12A. In this case, the second axis of rotation D2 is defined both by the pin 18, 19, 20 and by the curvature of the first guide face. However, the center of curvature of the first guide face 11a can also be located at a distance from the central axis M18 of the at least one pin 18, 19, 20, as is shown by way of example in FIGS. 14 and 18. In this case, the second axis of rotation D2 of the joint device 1 is preferably defined by the curvature of the first guide face 11a. In this case, the pin 18, 19, 20 can be connected to the fixing structure 3 for conjoint rotation.

In the following, embodiments of the joint device are described in which the connection portion 15 of the inner body 13 can be connected to the fixing structure 3 by means of the at least one pin 18; 19; 20, and the bearing shell 10 can be connected to the functional component 2. In particular, it can be provided in this case that the connection portion 15 can be connected to the fixing structure 3 by means of the pin 18, 19, 20 so as to be able to rotate about the second axis of rotation D2, the pin 18; 19; 20 defining the second axis of rotation D2. Alternatively to this, it can be provided that, by means of the pin 18, 19, 20, the connection portion 15 can be arranged in a stationary manner or for conjoint rotation with respect to the fixing structure 3, and the second axis of rotation D2 is defined by the curvature of the first guide face 11a.

FIGS. 1 to 5 and 7 to 10 show embodiments of the joint device 1 in which the connection portion 15 can be connected to the fixing structure 3 by means of the pin 18, 19, 20 so as to be able to rotate about the second axis of rotation D2.

The first guide body 11 of the bearing shell 10 can, as shown, in particular, in FIG. 1, be in the form of a shell-shaped structure which can be arranged on or is formed on a first end portion 4 of the functional component 2. Advantageously, the first guide body 11 can be formed in one piece with the end portion, as shown in FIGS. 1 to 3, 5 and 8. In this case, the first end portion 4 of the functional component 2 comprises the first guide face 11a. Such a design of the first guide body 11 has the advantage that the joint device 1 is already assembled in part on the functional component 2, as a result of which the time required for installing the joint device 1 is reduced.

The first guide body 11 or the bearing shell 10 as a whole can, however, also be designed so that it can be fixed to the functional component 2 by means of a fixing device 40, as shown by way of example in FIG. 9. The fixing device 40 can advantageously also be produced as a threaded shaft protruding from the first guide body 11, which shaft can be screwed into a fixing recess 41 in the functional component 2. Advantageously, a locking ring 42 can further be provided in this case. In this way, a means of adjusting the distance between the end portion 4 of the functional component 2 and the bearing shell is provided at the same time. It is also conceivable for the fixing device 40 to be produced as a pin or the like which can be fixed in the fixing recess 41 by means of a snap-in locking device or the like.

FIGS. 1 to 5 and 7 to 10 show, by way of example, that the first guide body 11 has a shell-shaped design comprising a first guide face 11a which is curved in a concave manner. However, the first guide body can also comprise a first guide face 11a which is curved in a convex manner. For example, the first guide face 11a can be produced as a convexly curved end face of the functional component 2, as shown in FIGS. 14 and 15. The first guide face 11a thus has a curvature in at least a first curvature direction having a constant first radius of curvature K1 about a first center of curvature. The curvature of the first guide face 11a thus defines a first axis of rotation D1 of the joint device 1, which extends through the center of curvature of the curvature of the first guide face 11a.

As shown, in particular, in FIG. 1, the guide portion 14 of the inner body 13 can be designed as a component which is curved in the shape of a shell. The guide portion 14 comprises the first bearing region 14b of the outer surface 14a of the inner body 13, which is shaped so as to be complementary to the first guide face 11a. The shell-shaped construction of the guide portion 14 results in a very compact construction of the joint device 14. In particular, as a result of the fact that the curvature of the first guide face 11a defines the first axis of rotation D1, the axis of rotation D1 can be located outside the guide portion 14 of the inner body 13. This has the advantage, in particular, that the connection portion 15 is designed to be independent of the first axis of rotation D1 and, in particular, can be adapted to the installation space which is available for the joint device 1.

As shown, in particular, in FIG. 2, the connection portion 15 can be formed, for example, by two tabs 15A, 15B protruding from the guide portion 14 of the inner body 13. On each of the tabs 15A, 15B, a guide recess 18A, 18B is formed in each case, through which the pin 18 extends, as shown in FIG. 5.

As shown in FIG. 6, the inner body 13 has an opening 17 formed in the guide portion 14. The opening can be in the form of a recess having a continuous circumferential edge, as shown in FIG. 7, or in the form of a slot which is open on one side, as shown in FIG. 6.

As shown in FIGS. 3, 5, 8 and 9, the second guide body 12 can have a convex/concave, in particular, a shell-shaped design. In this case, an end face 12b which has the opposite orientation to the second guide face 12a has a curvature which is the opposite of the curvature of the second guide face 12a.

Advantageously, the second guide face 12a can have the same center of curvature as the first guide face 11. By means of this structure of the second guide body 12, a low weight of the joint device 1 is firstly achieved. Furthermore, part of the fixing structure 3 can protrude into the cavity formed by the curvature of the second guide face 12a. As a result, the joint device 1 only requires a very small installation space.

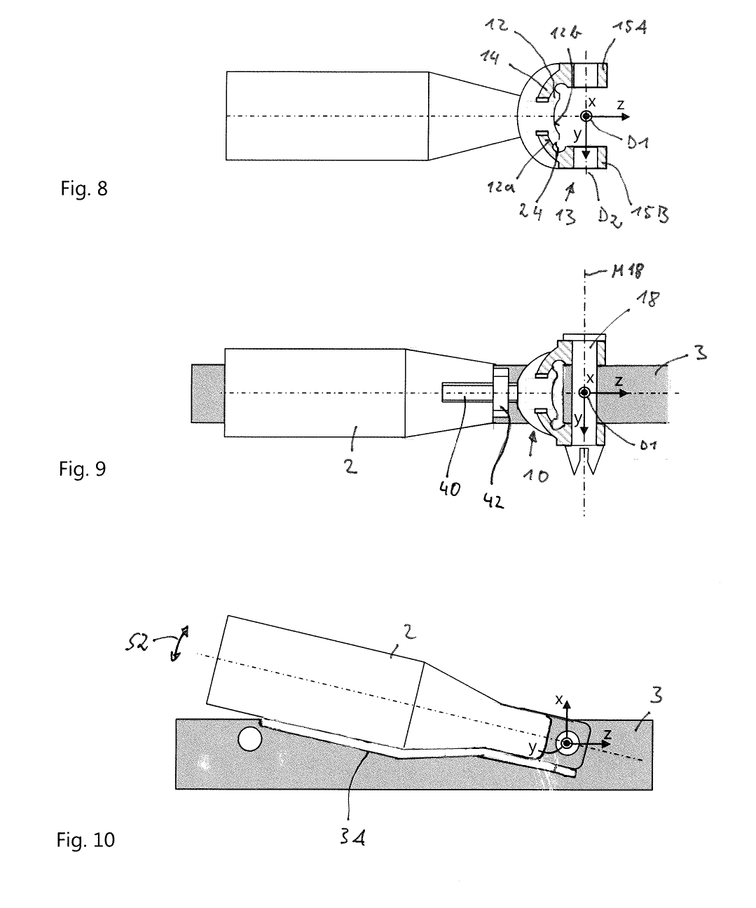

As shown by way of example in FIGS. 8 and 9, at a peripheral portion of the second guide body 12 connecting the second guide face 12a and the end face 12b, an undercut recess 24 can preferably be formed. The recess makes it possible to increase the pivotability of the bearing shell 10 about the first axis of rotation D1. This is advantageous, in particular, when the fixing structure 3, as shown in FIG. 9, has a rectangular cross section. In this case, the fixing structure 3 can have a recess 3A into which the functional component 2 can be pivoted during a movement in the second pivoting direction S2.

In the embodiments of the joint device 1 which are shown in FIGS. 1 to 5 and 7 to 10, the first guide face 11a can be curved in a cylindrical or spherical manner A cylindrical curvature has the advantage of being simple to produce. In this way, a rotation about the z axis of the coordinate system drawn in FIG. 5 is also prevented, since the first guide face 11a and the correspondingly complementarily shaped bearing region 14b which is formed on the guide portion 14 of the inner body 13 form an interlocking fit with respect to the rotation about the z axis. By means of a spherical curvature, the degrees of freedom of the joint device 1 are increased.

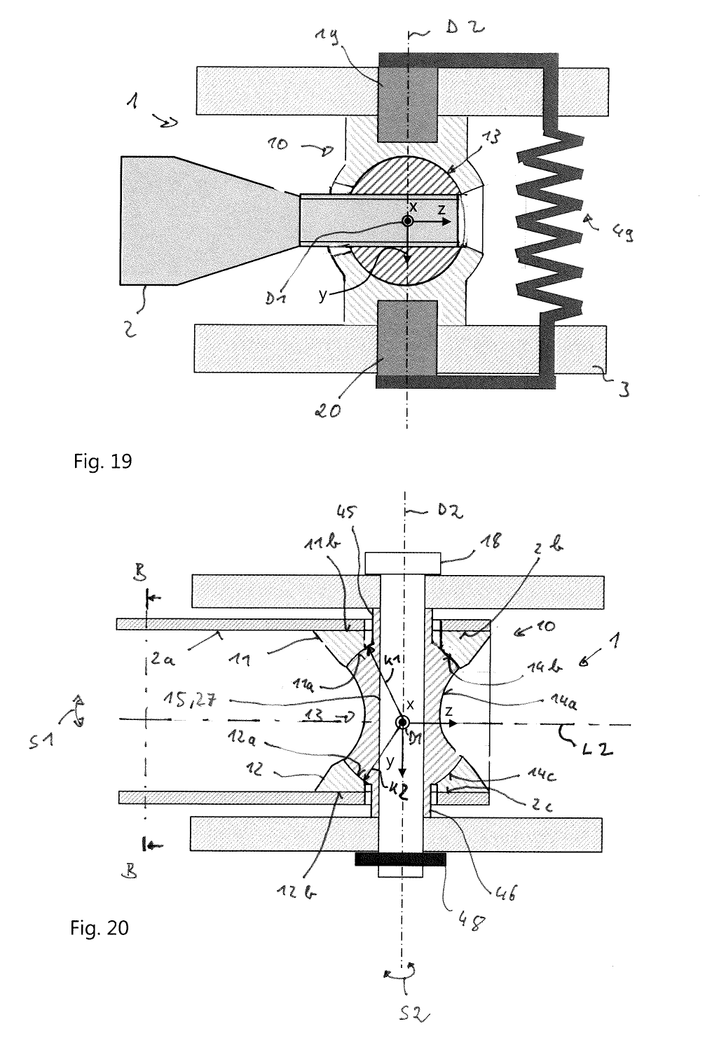

The pin 18 extends through the recesses 18A, 18B in the tabs 15A, 15B and allows a rotation of the inner body 13 about the second axis of rotation D2, as shown by way of example in FIG. 5. It is also conceivable for two separate pins 19, 20 having aligned central axes to be used to connect the tabs 15A, 15B to the fixing structure 3, similarly to as shown in FIG. 19. In particular, if only one individual pin 18 is provided, as shown in FIG. 5, the pin 18 can advantageously be fixed to the fixing structure 2 by a latching mechanism which is shown only schematically in FIG. 5. For this purpose, for example, an elastically deformable end portion 18E can be provided on the pin 18, which portion engages in an interlocking manner behind a region defining a recess 8 in the fixing structure 3 with respect to the central axis M18 of the pin 18.

By means of a fixing shaft 21, the second guide body 12 can be arranged in a stationary manner with respect to the first guide body 11, the fixing shaft 21 being connected to the first and the second guide body 11, 12.

As shown in FIGS. 3, 5 and 8, the first guide body 11 and the second guide body 12 can each be formed in one piece with the fixing shaft 21. Such a construction of the bearing shell 10 can, for example, be produced in a particularly advantageous manner in a 3D-printing process. In this case, the inner body 13 comprises a guide portion 14 having an opening which is produced as a slot 17 that is open on one side, as shown by way of example in FIG. 6. In this way, the inner body 13 can be introduced between the first and the second guide body 11, 12 in such a way that the fixing shaft 21 extends through the slot 17.

As shown in FIG. 1, the fixing shaft 21 can also be formed in one piece with the first guide body 11 and protrude from the first guide face 11a. In this case, the second guide body 12 has a recess 22 in which the fixing shaft 21 is received with an interlocking and/or force fit. For example, receiving with an interlocking fit can be achieved by a locking ring 42, as shown by way of example in FIG. 1. Alternatively or additionally, the recess 22 in the second guide body 12 can also form an interference fit with the fixing shaft 21, by means of which the second guide body 12 is fixed with a force fit with respect to the first guide body 11. These types of connection with an interlocking or force fit offer the advantage that the second guide face 12a of the second guide body 12 does not have to be designed in a spherical or generally rotationally symmetrical manner about the longitudinal axis of the fixing shaft 21, which, in the present case, extends along the z axis of the coordinate system. In this way, it is ensured that the joint device 1 is easy to assemble. If the second guide face 12a of the second guide body 12 is designed to be rotationally symmetrical about the longitudinal axis of the fixing shaft 21, the second guide body 12 can also be designed so that it can be screwed onto the fixing shaft 21. In this case, the fixing shaft 21 comprises a thread, and the recess 22 in the second guide body 12 comprises a corresponding counter-thread.

Furthermore, it can also be provided that, in order for the second guide body 12 to be arranged in a stationary manner with respect to the first guide body 11, the fixing shaft 21 is formed in one piece with the second guide body 12 and protrudes from the second guide face 12a, and the first guide body 11 has a recess 23 in which the fixing shaft 21 is received with an interlocking and/or force fit. In this case, it is preferably provided that the fixing shaft 21 comprises a thread, and the recess 23 in the first guide body 11 comprises a corresponding counter-thread. However, the fixing shaft 21 can also be fixed in the recess 23 in the first guide body 11 with an interlocking fit by means of a snap-in locking device or the like. It is also conceivable for the fixing shaft 21 and the recess to form an interference fit which ensures a force-fit connection.

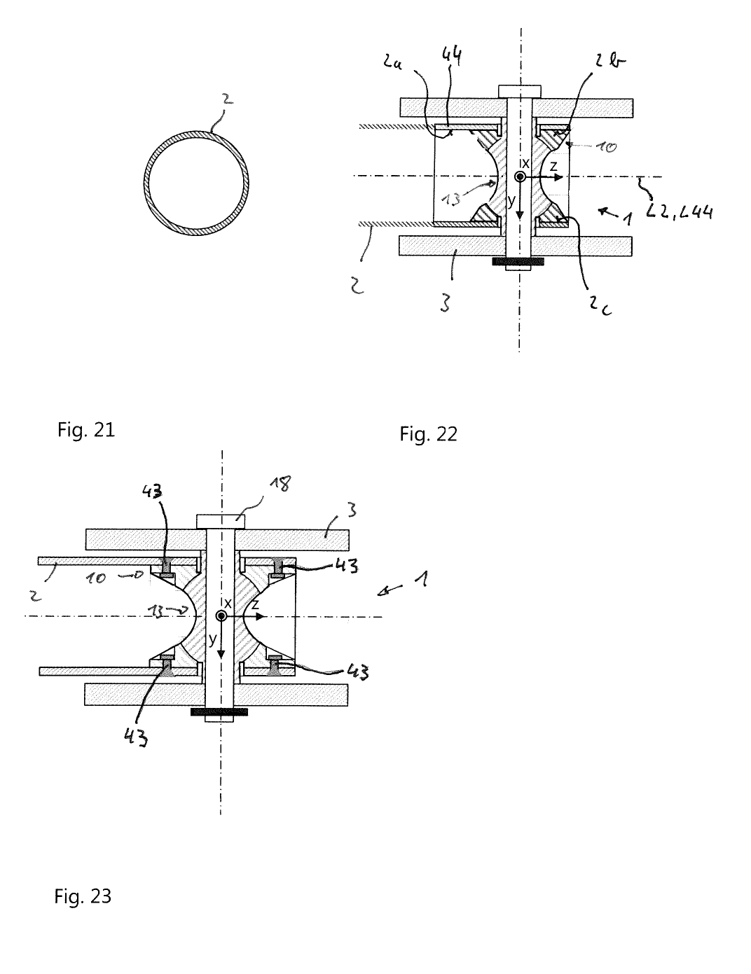

FIGS. 20, 22 and 23 show additional embodiments of the joint device 1 in which the connection portion 15 of the inner body 10 can be connected to the fixing structure 3 by means of the pin 18, 19, 20 so as to be able to rotate about the second axis of rotation D2, and the bearing shell 10 can be connected to the functional component 2. The embodiments of the joint device 1 which are shown in FIGS. 20, 22 and 23 are suitable, in particular, for integration in a functional component 2 which is in the form of a hollow body, for example a functional component 2 having a circular or tubular cross section. FIG. 21 shows by way of example a cross-sectional shape of this type of the functional component 2.

As shown, in particular, in FIG. 20, the first guide body 11 comprises an end face 11b which has the opposite orientation to the first guide face 11a, for fixing to a first region 2b of a mounting surface 2a, 2b, 2c of the functional component 2. The second guide body 12 comprises a second end face 12b which has the opposite orientation to the second guide face, for fixing to a second region 2c of the mounting surface 2a, 2b, 2c of the functional component 2.

The first and the second end face 12a, 12b can be designed, in particular, to be complementary to the regions 2b, 2c of the mounting surface 2a, 2b, 2c and to bear against the regions in a planar manner.

The first and the second guide body 11, 12 can be arranged in a stationary manner with respect to one another by means of the fact that the bodies, as shown in FIG. 20, are adhered to the regions 2b, 2c of the mounting surface 2a, 2b, 2c or, as shown in FIG. 23, are fixed thereto by means of fixing devices 43, for example in the form of rivets or screws. Furthermore, the first and the second guide body 11, 12 can be formed in one piece with the functional component 2, for example by means of a 3D-printing process, by means of which the inner body 13 can also be produced at the same time.

It is also conceivable for the guide bodies 11, 12 to be fixed to, or formed in one piece with, one of the above-mentioned types of receiving attachment 44, which comprises the regions 2b, 2c of the mounting surface 2a, 2b, 2c. The receiving attachment 44 can be connected to the functional component 2.

In order to mount the joint device 1 on the mounting surfaces 2a, 2b, 2c, the functional component 2 or the receiving attachment 44 can be divisible along the longitudinal axis L2 or L44 thereof.

In the embodiments shown in FIGS. 20, 22 and 23, the first and second guide faces 11a, 12a can each have a concave curvature having the same center of curvature, in particular, having the same radii of curvature K1, K2. In this case, by means of a coordinate system which is drawn with respect to the z axis in FIG. 20, a symmetrical construction of the joint device can be achieved.

However, it is also conceivable for the first and second guide faces 11a, 12a to each be curved oppositely to one another with the same center of curvature, as has already been described by way of example for the embodiments of the joint device 1 shown in FIGS. 3, 5, 8 and 9. For example, as shown in FIG. 20, the first guide face 11a can be curved in a concave manner, and the second guide face 12a can be curved in a convex manner. In this way, the joint device 1 can advantageously also be integrated in functional components 2 having a small inside diameter.

The guide portion 14 of the inner body 13 has an outer surface 14a, 14b, 14c which bears against bearing regions 14b, 14c on the guide faces 11a, 12a. In this case, at least one of the bearing regions 14b, 14c is curved in a complementary manner to the respective guide faces 14a, 14b and bears against the respective faces. In this way, the guide portion 14 of the inner body 13 is guided in a movable manner on the first and the second guide face 11a; 12a about the first axis of rotation D1 which is defined by the curvature of the first guide face 11a.

On the guide portion 14, spacers 45, 46 can be arranged on end portions which are opposed with respect to the second axis of rotation D2. As shown in FIG. 20, the spacers can be formed in one piece with the guide portion 14. However, it is also conceivable for the spacers 45, 46 to be produced as separate components in the form of sleeves.

In order to connect the inner body 13 to the fixing structure 3, a continuous pin 18 can be provided, which extends through an opening 27 which is formed in the guide portion 14 of the inner body 13, which forms the connection portion 15. The pin 18 can be fixed to the fixing structure 3, for example by means of a locking ring 48. However, the variants of the fixing of the pin 18 which are described in greater detail in the following are also conceivable. Instead of the one pin 18, two pins 19, 20 having aligned central axes M18 can also be used, which are inserted into the opening 27 from opposite sides.

In the embodiments shown in FIGS. 20, 22 and 23, the first guide face 11a can also be curved in a cylindrical or spherical manner A cylindrical curvature has the advantage of being simple to produce. In this way, a rotation about the z axis of the coordinate system drawn in FIG. 20 is also prevented, since the first guide face 11a and the correspondingly complementarily shaped bearing region 14b which is formed on the guide portion 14 of the inner body 13 form an interlocking fit with respect to the rotation about the z axis. By means of a spherical curvature, the degrees of freedom of the joint device 1 are increased.

FIGS. 14 and 15 show additional embodiments of the joint device 1 in which the connection portion 15 can be connected to the fixing structure 3. Preferably, the connection portion 15 can be connected to the fixing structure 3 in this case in such a way that the connection portion 15 is arranged in a stationary manner with respect to the fixing structure 3, the first guide face 11a defines the second axis of rotation D2 in that the face is spherically curved in a convex or concave manner. However, the second axis of rotation D2 can also be defined by the central axis of the pin 18.

In the embodiments shown in FIGS. 14 and 15, the first guide body 11 on an end portion 4 of the functional component 2 is formed in one piece therewith, and the end portion 4 comprises the first guide face 11a. However, in the embodiments shown in FIGS. 14 and 15, the first guide body 11 can also be formed as a separate component which can be connected to the functional component 2.

The first guide face 11a has a curvature in at least a first curvature direction having a constant first radius of curvature K1 about a first center of curvature. The first curvature of the guide face 11a thus defines the first axis of rotation D1 of the joint device 1, which extends through the center of curvature of the curvature of the first guide face 11a.

The second guide body 12 comprises the second guide face 12a, the guide face preferably having the opposite curvature to that of the first guide face 11a according to the view in FIGS. 14 and 15. For example, the second guide face 12a can be curved in a concave manner. However, it is also conceivable for the second guide face 12a to have a planar design.

As shown in FIGS. 14 and 15, bearing regions 14b, 14c of the outer surface 14a, 14b, 14c of the guide portion 14 of the inner body 13, which bearing regions are curved so as to be complementary to the guide faces 11a, 12a, bear against the guide faces 11a, 12a. The guide portion 14 of the inner body 13 is thus guided in a movable manner on the first and the second guide face 11a; 12a about the first axis of rotation D1. As described above, the first axis of rotation D1 is defined by the curvature of the first guide face 11a.

The guide portion 14 of the inner body 13 can be designed as a component which is curved in the shape of a shell, as shown in FIGS. 14 and 15. As shown in FIG. 14, the connection portion 15 of the inner body can have an approximately L-shaped design or, as shown in FIG. 15, an approximately funnel-shaped design.

As shown by way of example in FIG. 15, the pin 18 can be formed in one piece with the connection portion 15 or, as shown in FIG. 14, as a separate component. The pin 18 can be connected in each case to the fixing structure 3, for example as shown in FIG. 15 by a locking nut 47, a locking ring or the like. As a result, the pin 18 can be mounted in the recess 8 in the fixing structure 3 so as to be able to rotate about the central axis M18 thereof. In this way, the pin 18 defines the second axis of rotation D2.

Preferably, however, the connection portion 15 can be connected to the fixing structure 3 in the embodiments shown in FIGS. 14 and 15 in such a way that the connection portion 15 is arranged in a stationary manner with respect to the fixing structure 3, and the first guide face 11a defines the second axis of rotation D2 in that the face is spherically curved in a convex or concave manner,

A stationary arrangement of the connection portion 15 with respect to the fixing structure 3 can be achieved, for example, in that the pin 18, as shown in FIG. 14, has a thread and can be screwed into a corresponding counter-thread which is provided on the connection portion 15.

The first guide face 11a has, in addition to the curvature in the first curvature direction, a curvature in a curvature direction extending perpendicularly to the first curvature direction which has a spherical radius of curvature KS1 which is equal to the first radius of curvature K1 and has the same center of curvature. This thus results in a spherical curvature of the first guide face 11a. The curvature of the guide face 11a in the second curvature direction thus defines, in this case, the second axis of rotation D2 of the joint device 1, which extends through the center of curvature of the curvature of the first guide face 11a.

As shown in FIGS. 14 and 15, the second guide body 12 can be arranged in a stationary manner with respect to the first guide body 11 by means of a fixing shaft 21, the fixing shaft 21 being connected to the first and the second guide body 11, 12.

FIGS. 14 and 15 show, by way of example, that, in order for the second guide body 12 to be arranged in a stationary manner with respect to the first guide body 11, the fixing shaft 21 is formed in one piece with the second guide body 12 and protrudes from the second guide face 12a, and the first guide body 11 has a recess 23 in which the fixing shaft 21 is received with an interlocking and/or force fit. In this case, it is preferably provided that the fixing shaft 21 comprises a thread, and the recess 23 in the first guide body 11 comprises a corresponding counter-thread. However, the fixing shaft 21 can also be fixed in the recess 23 in the first guide body 11 with an interlocking fit by means of a snap-in locking device or the like. It is also conceivable for the fixing shaft 21 and the recess to form an interference fit which ensures a force-fit connection.

However, the second guide body 12 can also be arranged in a stationary manner with respect to the first guide body 11 in the ways which have already been described with reference to FIGS. 1 to 10.

In the following, embodiments of the joint device are described in which the bearing shell 10 can be connected to the fixing structure 3 by means of the at least one pin 18, 19, 20, and the connection portion 15 can be connected to the functional component 2. In particular, it can be provided in this case that the bearing shell 10 can be connected to the fixing structure 3 by means of the pin 18, 19, 20 so as to be able to rotate about the second axis of rotation D2, the pin 18 defining the second axis of rotation. Alternatively to this, it can be provided that the bearing shell 10 can be connected to the fixing structure 3 by means of the pin 18, 19, 20 in such a way that the bearing shell 10 is arranged in a stationary manner with respect to the fixing structure 3.

FIGS. 11 to 13 and 17 to 19 show embodiments of the joint device 1 in which the bearing shell 10 can be connected to the fixing structure 3 by means of the at least one pin 18, 19, 20, and the connection portion 15 can be connected to the functional component 2. In this case, the first guide body 11 comprises an end face 11b which has the opposite orientation to the first guide face 11a, which end face is provided to bear against a first portion of the fixing structure 3. Furthermore, the second guide body 12 comprises an end face 12b which has the opposite orientation to the second guide face 12a for bearing against a second portion of the fixing structure 3. The connection portion 15 of the inner body 13 is further designed for connection to the functional component 2.

As shown in FIGS. 11 to 13, the guide bodies 11, 12 can each be produced as block-shaped or board-shaped components which comprise the guide faces 11a, 12a on one side of the board and the end faces 11b, 12b on an opposite side. Due to the curvature of the first guide face 11a, which defines the first axis of rotation D1, an extremely compact construction is achieved by the end faces 11a, 12a which are provided for bearing against the fixing structure 3, since the location of the first axis of rotation D1 can be freely selected through the curvature of the first guide face 11a. As a result, the joint device 1 ensures flexible adjustment of the functional component 2, even in tight space conditions.

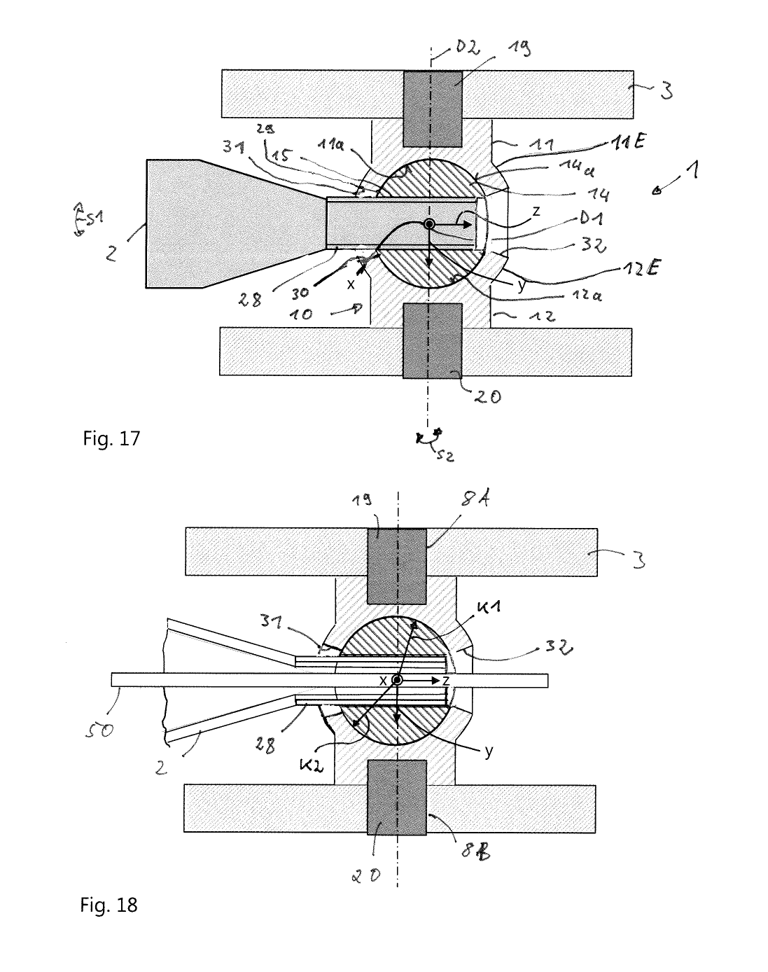

The guide bodies 11, 12 can also be produced as block-shaped parts, on which a shell-shaped portion 11E, 12E is formed, which comprises the guide faces 11a, 12a, as shown, in particular, in FIG. 17. In this way, in particular, a symmetrical construction of the joint device 1 can be achieved.

Generally, the first guide face 11a has a curvature in at least a first curvature direction having a constant first radius of curvature K1 about a first center of curvature. The curvature of the first guide face 11a thus defines the first axis of rotation D1 of the joint device 1, which extends through the center of curvature of the curvature of the first guide face 11a.

As shown by way of example in FIG. 12A, the first and the second guide bodies 11, 12 can be in the form of two separate components. This has the advantage that the spacing of the guide bodies 11, 12 can easily be adapted to the spacing of the mounting regions which are formed on the fixing structure 3.

As shown by way of example in FIG. 12B, it can also be provided that the first and the second guide bodies 11, 12 are interconnected by a web 10A extending along the second axis of rotation D2, the web 10A being able to be formed in one piece with the first and second guide bodies 11, 12. The web 10A has the advantage that any expanding forces which may occur as a result of a tensile force acting along the longitudinal axis L2 of the functional component 2, which expanding forces act as a result of the curvature of the guide faces 11a, 12a and of the guide portion 14 in the y direction of the coordinate system drawn in FIG. 11 or in FIG. 17, are not transmitted, or are only transmitted to a limited extent, to the fixing structure 3.

According to the drawings in FIGS. 11 to 13, the first guide face 11a has a concave curvature. However, the face can also be curved in a convex manner. The second guide face 12a of the second guide body 12 preferably has a curvature which is complementary to the curvature of the first guide face 11a, as shown by way of example in FIGS. 11 to 13. However, in the embodiments shown in FIGS. 11 to 13, the second guide face can also be planar.

As an alternative to the second guide face 12a of the second guide body 12 having a curvature which is complementary to the curvature of the first guide face 11a, it can be provided that both the first and second guide faces 11a, 12a are curved in a concave manner, as shown by way of example in FIGS. 17 to 19.

The first guide face 11a can have, in addition to the curvature in the first curvature direction, a curvature in a curvature direction extending perpendicularly to the first curvature direction which has a spherical radius of curvature KS1 which is equal to the first radius of curvature K1 and has the same center of curvature, as shown by way of example in FIG. 12A. This thus results in a spherical curvature of the first guide face 11a. In this case, the curvature of the guide face 11a in the second curvature direction can also define the second axis of rotation D2 of the joint device 1.

However, in the embodiments shown in FIGS. 11 to 13 and 17 to 19, the first guide face 11a is preferably curved only in the first curvature direction and thus in a cylindrical manner, the second axis of rotation D2 being defined by the pin 18, 19, 20.

The guide portion 14 of the inner body 13 can have, in particular, a shell-shaped design, as shown in FIGS. 11 to 13, or a cylindrical design, as shown in FIGS. 17 to 19. In this case, the pin 18, 19, 20 defines the second axis of rotation D2, and the guide body 11, 12 and thus the bearing shell 10 are mounted by the pin 18, 19, 20 so as to be able to rotate about the second axis of rotation D2.

If the first guide face 11a and, in particular, if both the first and second guide faces 11a, 12a are curved in a spherical manner, the second axis of rotation D2 of the joint device 1 can also be defined by the curvature of the first guide face 11a. The guide bodies 11, 12 shown in FIGS. 17 to 19 can also be suitable, for example, for guiding a spherical inner body 13 when the bodies comprise guide faces 11a, 12a which are each curved in a spherical manner.

The pin 18, as shown by way of example in FIGS. 11, 12A and 12B, can extend through an opening 25 formed in the first guide body 11, an opening 26 formed in the second guide body 12, and an opening 27 formed in the guide portion 14 of the inner body 13 respectively. In this way, the joint device 1 can be connected to the fixing structure 3 by means of very few components. The pin 18 can be secured to the fixing structure 3, for example as shown in FIG. 5, by means of an elastically deformable end portion 18E, or as shown in FIG. 20, by means of a locking ring 48.

Alternatively to this, it can be provided that in each case one pin 19, 20 engages from the end face 11b, 12b of each guide body 11, 12 into the opening 25, 26 of each guide body 11, 12, as shown by way of example in FIGS. 13 and 17 to 19. The pins can be secured in the respective recesses 8A, 8B in the fixing structure 3, for example by frictional locking, the respective pins 19, 20 and the respective recesses 8A, 8B forming an interference fit. It can also be provided that the pins 19, 20 are biased by means of a preloading element 49, which is shown schematically in FIG. 19 and which preloads the pins in directions which are directed towards one another along the central axes M18 thereof. Such fixing by means of two pins 19, 20 and an optional preloading element 49 can also be provided in the other embodiments shown in the figures.

As shown in FIGS. 17 to 19, the connection portion 15 of the inner body 13 can be in the form of a fixing recess 28 extending transversely to the first axis of rotation D1. The fixing recess can advantageously also be in the form of a through-hole or a blind hole. The end portion 4 of the functional component 2 can be fixed in the fixing recess 28. For example, it can be provided that the end portion 3 has a thread, and a corresponding counter-thread is formed in the fixing recess 28, and the end portion 4 can be screwed into the fixing recess 28, as shown by way of example in FIGS. 17 to 19. It can, for example, also be provided that the end portion 4 has a locking portion (not shown) or the like, and the fixing recess 28 has a locking bearing (not shown) so that the end portion 4 can be fixed in the fixing recess 28 with an interlocking fit.

A wall 29 of the first guide body 11 and a wall 30 of the second guide body 12 together form an introduction opening 31 in the bearing shell 10. If the first and second guide bodies 11, 12 are formed in one piece, the introduction opening 31 can be produced, for example, as a hole. In particular, if the first and second guide bodies 11, 12 are produced as two separate parts, the introduction opening 31 can also be defined as a gap arising between the end portions of the walls 29, 30. The end portion 4 of the functional component 2 can be guided through the introduction opening 31.

The wall 29 of the first guide body 11 and the wall 30 of the second guide body 12 can, in particular, also form a functional opening 32 in the bearing shell 10, the functional opening 32 being placed opposite the introduction opening 31, as shown in FIGS. 17 to 19. In this way, a through-channel which extends through the bearing shell 10 is formed. This has the advantage that, as shown by way of example in FIG. 18, cable or actuating elements 50, such as cable pulls, fluid lines, electric cables or the like, extending inside the functional component 2 can be guided through the bearing shell 10.

FIG. 16 shows another embodiment of the joint device 1 in which the bearing shell 10 can be connected to the fixing structure 3 by means of the at least one pin 18, 19, 20, and the connection portion 15 can be connected to the functional component 2. In this case, the first guide body 11 comprises an end face 11b which has the opposite orientation to the first guide face 11a, which end face is provided to bear against a first portion of the fixing structure 3. The first guide body 11 can, in particular, have the same construction, as described with reference to FIGS. 11 to 13.

By contrast with the embodiments shown in FIGS. 11 to 13, the pin 18 and the second guide body 12 are formed in one piece with one another. As shown in FIG. 16, the pin 18 protrudes from the second guide face 12a of the second guide body 12 and extends through openings 25, 27 formed in the first guide body 11 and the guide portion 14 of the inner body 13 respectively. The pin 18 is designed so that it can be fixed to the fixing structure 3, as a result of which the second guide body 12 is arranged in a stationary manner with respect to the first guide body 11. Preferably, the pin 18, as shown in FIG. 16, has a thread and can be screwed into the recess 8A in the fixing structure 3, which has a corresponding counter-thread. However, it is also possible to fix the pin 18 by means of a fixing ring, a fixing nut or the like.

The second guide face 12a is preferably curved in a spherical manner. The first guide face 11a can be curved in a spherical or cylindrical manner A variant, as shown in FIG. 16, in which the pin 18 is in the form of a fixing screw is preferred. In this case, the first guide body 11 can be fixed by the pin 18 so as to be stationary with respect to the fixing structure 3, and both the first and the second axis of rotation D1, D2 are defined by the curvature of the first guide face 11a.

Generally, it can be provided that, in the case where the bearing shell 10 can be connected to the fixing structure 3 by means of the at least one pin 18, 19, 20 in such a way that the pin 18, 19, 20 defines the second axis of rotation D2 and the bearing shell 10 can be rotated about the second axis of rotation D2, the first guide face 11a is curved in a spherical or cylindrical manner. In the case where the connection portion 15 is arranged in a stationary manner with respect to the fixing structure 3, the first guide face 11a is curved in a spherical manner.

In all the embodiments of the joint device 1 in which the first guide face 11a is curved in a spherical manner, a blocking portion 16 can be provided which prevents a rotation of the inner body 13 and the bearing shell 10 relative to one another in a third axis of rotation which extends transversely to the first and the second axis of rotation D1, D2.

For example, the fixing shaft 21 or the pin 18 can comprise a blocking portion 16 which is placed in the opening 27 formed in the guide portion 14 of the inner body 13. In this case, the opening 27 and the blocking portion 16 each have a cross-sectional shape which is not rotationally symmetrical with respect to the third axis of rotation.

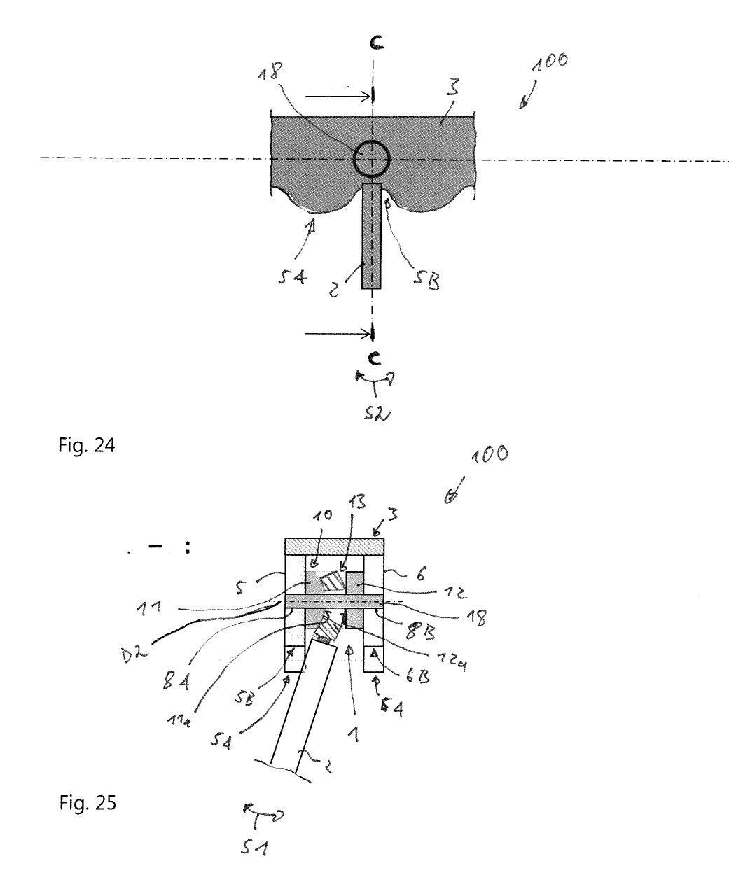

FIGS. 24 and 25 show, by way of example, an embodiment of a guide arrangement 100 according to the present invention. The guide arrangement comprises a functional component 2. These can be formed, in particular, in one of the ways described above. The guide arrangement further comprises a fixing structure 3. The structure is in the form of a U-shaped profile which comprises two lateral struts 5, 6 which are opposite one another and a transverse strut 7 which extends transversely thereto and connects the struts. The lateral struts 5, 6 of the fixing structure 3 each comprise a recess 8A, 8B.

The fixing structure 3 can be formed, for example, by a frame of a fuselage of an aircraft or can be fixed to a fuselage structure of a fuselage of an aircraft.

The guide arrangement 100 further comprises a joint device 1 which is formed in one of the ways described above. FIG. 25 shows, by way of example, a variant of the joint device 1 shown in FIG. 11, in which the first guide face 11a of the first guide body 11 is curved in a cylindrical, convex manner, and the second guide face 12a of the second guide body 12 has a planar design.

The lateral struts 5, 6 of the fixing profile can comprise elevations 5A, 6A and depressions 5B, 6B alternately on the end portions thereof with respect to the longitudinal extension of the fixing profile. During the movement of the functional component 2 about the first axis of rotation D1, a portion of the functional component 2 can be received in one of the depressions 5B, 6B, as shown by way of example in FIG. 25. This has the advantage that the angle of rotation about the first axis of rotation by which the functional component 2 can be pivoted or moved is increased.

The elevations 5A, 6A and depressions 5B, 6B can, as shown in FIG. 24, form a wave-shaped course of the edge of the end portion of the lateral struts 5, 6. However, it is also conceivable for the elevations 5A, 6A and depressions 5B, 6B to form, for example, a crenellated or sawtooth-shaped course of the edge of the end portion of the lateral struts 5, 6.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A joint device for rotatably connecting a functional component to a fixing structure, comprising:
a bearing shell having a first guide body which has a first guide face extending in a curved manner, and a second guide body which is arranged in a stationary manner with respect to the first guide body, which second guide body has a second guide face which faces the first guide face of the first guide body, the bearing shell being connectable to one part from the group comprising the functional component and the fixing structure; and
an inner body having a connection portion and a guide portion arranged between the first and the second guide face, the connection portion being connectable to the other part from the group comprising the functional component and the fixing structure;
the guide portion of the inner body being guided in a movable manner on the first and the second guide face about a first axis of rotation which is defined by the curvature of the first guide face; and
the connection portion of the inner body or the bearing shell being connectable to the fixing structure by at least one pin, with a second axis of rotation extending transversely to the first axis of rotation being defined by a central axis of the pin and/or the curvature of the first bearing face.

2. The joint device of claim 1, wherein the connection portion of the inner body can be connected to the fixing structure by means of the at least one pin in such a way that the pin defines the second axis of rotation, and the connection portion can be rotated about the second axis of rotation, or in such a way that the connection portion is arranged in a stationary manner with respect to the fixing structure, and the second axis of rotation is defined by the curvature of the first guide face, and the bearing shell can be connected to the functional component.

3. The joint device of claim 2, wherein, in the case where the connection portion can be connected by means of pins to the fixing structure so as to be able to rotate about the second axis of rotation, the connection portion is formed by two tabs protruding from the guide portion of the inner body, which tabs each comprise a guide recess, through which the pin extends.

4. The joint device of claim 3, wherein the second guide body has a convex/concave design, an end face which has the opposite orientation to the second guide face having a curvature which is the opposite of the curvature of the second guide face, an undercut recess preferably being formed on a peripheral portion of the second guide body connecting the second guide face and the end face.

5. The joint device of claim 2, wherein, in the case where the connection portion can be connected by means of the pin to the fixing structure so as to be able to rotate about the second axis of rotation, the first guide body has an end face which has the opposite orientation to the first guide face for fixing to a first region of a mounting surface of the functional component, and the second guide body has a second end face which has the opposite orientation to the second guide face for fixing to a second region of the mounting surface of the functional component.

6. The joint device of claim 5, wherein the first and second guide faces respectively have concave curvatures, said curvatures having the same center of curvature, or
wherein the first and second guide faces respectively have opposite curvatures, said curvatures having the same center of curvature,
an outer surface of the guide portion of the inner body which has bearing regions that are curved in a complementary manner to the guide faces bearing against said guide faces.

7. The joint device of claim 2, wherein the first guide face is curved in a cylindrical or spherical manner.

8. The joint device of claim 2, wherein, in the case where the connection portion can be connected to the fixing structure in such a way that the connection portion is arranged in a stationary manner with respect to the fixing structure, the first guide face defines the second axis of rotation in that said face is spherically curved in a convex or concave manner,
the second guide face having an opposite curvature to the first guide face, and
an outer surface of the guide portion of the inner body which has bearing regions that are complementary to the guide faces bearing against said guide faces.

9. The joint device of claim 2, wherein the first guide body is formed on an end portion of the functional component, preferably is formed in one piece therewith, which portion comprises the first guide face.

10. The joint device of claim 2, wherein the second guide body is arranged in a stationary manner with respect to the first guide body by means of a fixing shaft, the fixing shaft being connected to the first and the second guide body.

11. The joint device of claim 1, wherein the bearing shell can be connected to the fixing structure by means of the at least one pin in such a way that the pin defines the second axis of rotation, and the bearing shell can be rotated about the second axis of rotation, or can be connected in such a way that the bearing shell is arranged in a stationary manner with respect to the fixing structure, and the connection portion of the inner body can be connected to the functional component.

12. The joint device of claim 11, wherein the first guide body comprises an end face which has an opposite orientation to the first guide face for bearing against a first portion of the fixing structure, and the second guide body comprises an end face which has an opposite orientation to the second guide face for bearing against a second portion of the fixing structure, and the connection portion of the inner body is designed for connection to the functional component.

13. The joint device of claim 12, wherein one of
the pin extends through openings which are formed respectively in the first and second guide bodies and the guide portion of the inner body, or
in each case, one pin engages from the end face of each guide body into the opening in each guide body.

14. The joint device of claim 11, wherein the connection portion of the inner body is in the form of a fixing recess extending transversely to the first axis of rotation, an end portion of the functional component being able to be fixed in the fixing recess, a wall of the first guide body and a wall of the second guide body forming an introduction opening in the bearing shell, through which the end portion of the functional component can be guided, and the wall of the first guide body and the wall of the second guide body forming a functional opening in the bearing shell, which is positioned opposite the introduction opening.

15. The joint device of claim 11, wherein the first guide body has an end face which has the opposite orientation to the first guide face for bearing against a first portion of the fixing structure, and the pin is formed in one piece with the second guide body and protrudes from the second guide face thereof, the second guide body being arranged in a stationary manner with respect to the first guide body in that the pin extends through openings which are formed respectively in the first guide body and the guide portion of the inner body and can be fixed to the fixing structure.

16. The joint device of claim 21, wherein, in the case where the bearing shell is configured to be connected to the fixing structure by means of the at least one pin in such a way that the pin defines the second axis of rotation and the bearing shell is rotatable about the second axis of rotation, the first guide face is curved in a spherical or cylindrical manner; and
wherein, in the case where the connection portion is arranged in a stationary manner with respect to the fixing structure, the first guide face is curved in a spherical manner.

17. A guide arrangement, comprising:
a functional component;
a fixing structure; and
a joint device having
a bearing shell having a first guide body which has a first guide face extending in a curved manner, and a second guide body which is arranged in a stationary manner with respect to the first guide body, which second guide body has a second guide face which faces the first guide face of the first guide body, the bearing shell being connectable to one part from the group comprising the functional component and the fixing structure; and
an inner body having a connection portion and a guide portion arranged between the first and the second guide face, the connection portion being connectable to the other part from the group comprising the functional component and the fixing structure;
the guide portion of the inner body being guided in a movable manner on the first and the second guide face about a first axis of rotation which is defined by the curvature of the first guide face; and
the connection portion of the inner body or the bearing shell being connectable to the fixing structure by at least one pin, with a second axis of rotation extending transversely to the first axis of rotation being defined by at least one of a central axis of the pin or the curvature of the first bearing face;
wherein the fixing structure is formed by a U-shaped profile which comprises a recess in each of the lateral struts thereof, in which the pin of the joint device is mounted.

18. The guide arrangement of claim 17, wherein the lateral struts have elevations and depressions alternately on the end portion thereof, a portion of the functional component being configured to be received in one of the depressions during the movement of said component about the first axis of rotation.

19. The joint device of claim 10, wherein the fixing shaft is formed in one piece with the first guide body and the second guide body.

20. The joint device of claim 10, wherein the fixing shaft is formed in one piece with the first guide body and protrudes from the first guide face, and the second guide body has a recess in which the fixing shaft is received with at least one of an interlocking or force fit.

21. The joint device of claim 10, wherein the fixing shaft is formed in one piece with the second guide body and protrudes from the second guide face, and the first guide body has a recess in which the fixing shaft is received with at least one of an interlocking or force fit.
